(19) United States
(12) Patent Application Publication
(10) Pub. No.: US 2003/0205928 A1
(43) Pub. Date: Nov. 6, 2003

(54) Optimised brake-apply sequence in electro-hydraulic (EHB) braking systems

(76) Inventors: Alan Leslie Harris, Coventry (GB); Mark Ian Phillips, Birmingham (GB)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/412,635

(22) Filed: Apr. 10, 2003

Related U.S. Application Data
(63) Continuation of application No. PCT/GB01/04577, filed on Oct. 15, 2001.

(30) Foreign Application Priority Data
Oct. 14, 2000 (GB) 0025237.9

(51) Int. Cl. B60T 13/00

(52) U.S. Cl. 303/9.62

(57) ABSTRACT

A vehicle electro-hydraulic braking system of the type which can operate in a brake-by-wire mode wherein hydraulic pressure is applied to brake actuators (16a, 16b) at the vehicle wheels in proportion to the driver's braking demand (DD) as sensed electronically at a brake pedal (12), wherein the pressure demand (RBD) for the rear brake actuators (16b) is arranged to be delayed until at least one or two conditions has been fulfilled, namely (a) the pressure of at least one front brake actuator (16a) has reached a predetermined pressure (Pmin), and/or (b) a delay threshold (Tmax) of a predetermined level has been exceeded and/or wherein delivery to the fluid to the rearbrake actuators (16b) is limited to a predetermined value that is relatively low with respect to that for the front brakes.

The present invention is concerned with improving efficiency of braking performance in vehicle braking systems, in particular within the context of vehicle braking systems having electro-hydraulic (EHB) braking.

A typical EHB system for a vehicle comprises a brake pedal, respective braking devices which are connected to the vehicle wheels and which are capable of being brought into communication with electronically controlled control valves in order to apply hydraulic fluid under pressure to the braking devices, a hydraulic pump driven by an electric motor, and a high pressure hydraulic pressure accumulator fed by said pump for the provision of hydraulic fluid under pressure which can be passed to the braking devices and the electrically controlled control valves in order, in so called “brake-by-wire” mode, to apply hydraulic fluid under pressure to the braking devices in proportion to the driver's demand as sensed at the brake pedal. The EHB system is controlled by an electronic controller (ECU). In the case of typical four-wheeled vehicles, there are four said braking devices at the two front wheels and two rear wheels of the vehicle, respectively.

Where the high pressure accumulator is fed by the pump via an accumulator valve, it is found in practice that the accumulator valve can restrict infill flow to the braking devices because the brake stiffness is low and total flow is high. A bigger valve to reduce this problem is impractical because of packaging and thermal problems

Furthermore, it is a feature of conventional systems that the braking devices at the rear wheels have a lower consumption of brake fluid than those at the front wheels because the calipers at the rear brakes are usually of smaller size than the calipers at the front brakes. It is therefore possible that the rear brakes pressure will increase faster than the front brakes pressure.

As a result of these characteristics, the effect is that front-brake pressure rise from zero can be delayed, leading to poor deceleration response, and rear-brake pressure often rises before front-brake pressure, leading to concern about vehicle stability.

There is therefore a requirement for these deleterious effects to be reduced.

In accordance with the present invention, the pressure demand for the rear brake actuators is arranged to be delayed until at least one of two conditions has been fulfilled, namely (a) the pressure of at least one front brake actuator has reached a predetermined pressure, and/or (b) a delay threshold of a predetermined level has been exceeded and/or wherein delivery of fluid to the rear brakes is limited to a predetermined value that is relatively low with respect to that for the front brakes.

A typical value for the predetermined pressure might, for example, be 2bar (=Pmin)and a typical value for the predetermined level might, for example, be 100-300 ms. (=Tmax). A typical value of the predetermined value might for example be 10% of the front brake level.

The aforegoing strategy would apply only to base-brake scenarios, including those triggered from an external system such as autonomous cruise control (ACC). It would therefore not apply to traction control (TC) or VSC, or during ABS.

Prioritising the front brakes in this way allows them to be filled more quickly without increasing the size of the accumulator valve, and avoids, the premature application of the rear brakes.

Responding to the first front brake to reach, say, 2bar is safe in the event of a failure at the one front brake.

Setting a maximum delay of, say, 300 ms is safe in the event that the front brakes respond too slowly due to e.g. air/knockback/taper wear of the linings.

The invention is described further hereinafter, by way of example only, with reference to the accompanying drawings in which:

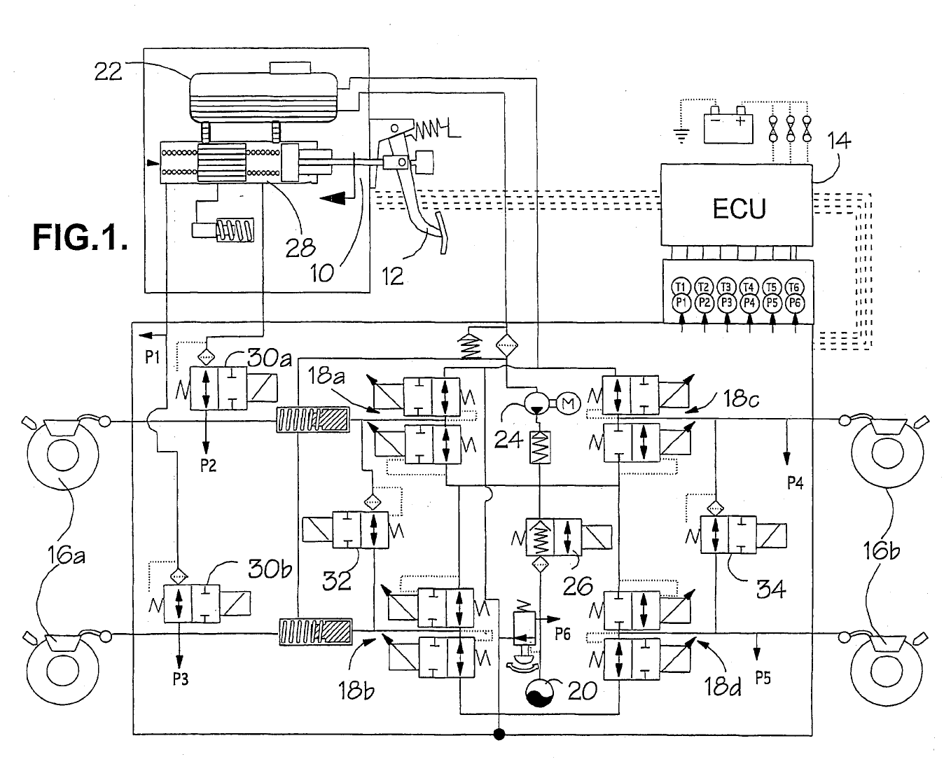

FIG. 1 is an illustration of one embodiment of an electro-hydraulic (EHB) braking system to which the present invention is applicable;

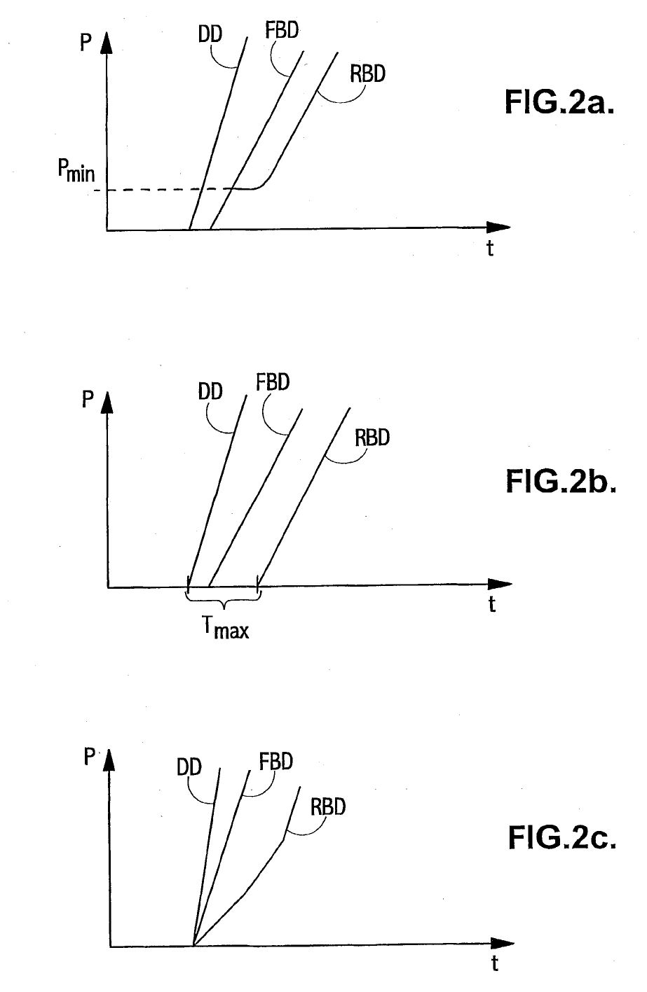

FIG. 2, 2a-2c illustrate graphically the three conditions mentioned above and;

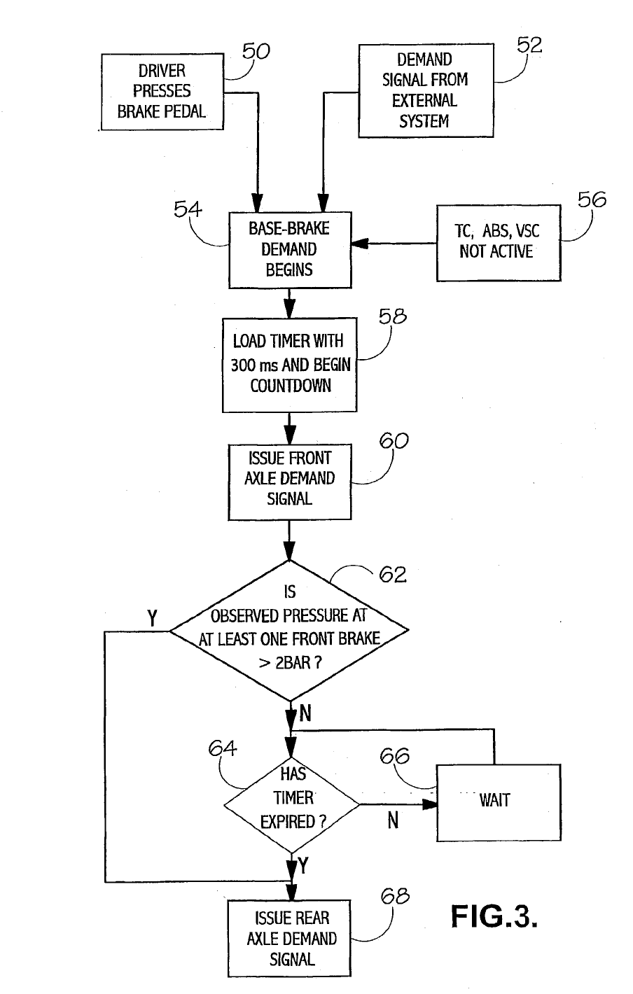

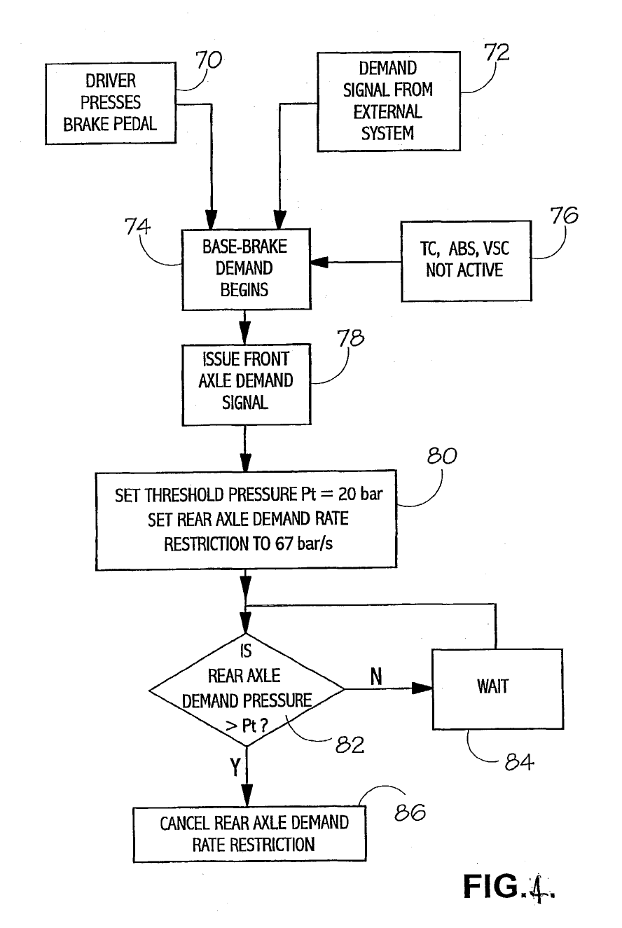

FIGS. 3 and 4 are simplified flow-charts illustrating systems operating in accordance with embodiments of the present invention.

FIG. 1 illustrates an electro hydraulic braking system where braking demand signals are generated electronically at a travel sensor 10 in response to operations of a foot pedal 12, the signals being processed in an electronic control unit (ECU) 14 for controlling the operation of brake actuators 16a, 16b at the front and back wheels respectively of a vehicle via pairs of valves 18a, 18b and 18c, 18d. The latter valves are operated in opposition to provide proportional control of actuating fluid to the brake actuators 16 from a pressurised fluid supply accumulator 20, maintained from a reservoir 22 by means of a motor-driven pump 24 via a solenoid controlled accumulator valve 26. For use, for example, in emergency conditions when the electronic control of the brake actuators is not operational for some reason, the system includes a master cylinder 28 coupled mechanically to the foot pedal 12 and by which fluid can be supplied directly to the front brake actuators 16a in a “push through” condition. In the push-through condition, a fluid connection between the front brake actuators 16a and the cylinder 28 is established by means of digitally operating, solenoid operated valves, 30a, 30b. Also included in the system are further digitally operating valves which respectively connect the two pairs of valves 36a, 36b, and the two pairs of valves 18c, 18d.

Referring to FIGS. 2a-2c, for the purposes of the present invention as applied to the system illustrated in FIG. 1, the ECU 14 is programmed to enable the pressure demand at the rear brake actuators 16b to be delayed until at least one of the two prescribed conditions has been fulfilled, namely that the pressure at at least one front brake actuator 16a has reached a predetermined pressure, such as 2bar (see FIG. 2a), and/or a delay threshold of a predetermined level, such as 300 ms, has been exceeded (see FIG. 2b) and/or delivery of fluid to the rear brakes is limited to a predetermined value that is relatively lower compared to that for the front brakes.

The figures of 2bar and 300 ms are given purely by way of illustration and are not intended to limit the invention to these figures.

In FIGS. 2a to 2c:

DD=Driver Demand

FBD=Front Brake observed brake pressure

RBD=Rear Brake Demand

FIG. 3 is a sequence flow diagram illustrating an embodiment corresponding to FIGS. 2a and 2b where the pressure demand for the rear brake actuators is delayed until the pressure of at least one front brake actuator has reached a predetermined pressure and/or a delay threshold has been exceeded. The flow diagram of FIG. 3 includes the following sequence steps:

50—Driver presses brake pedal.

52—Demand signal from external system.

54—Base-brake demand begins

56—TC, ABS, VSC not active.

58—Load timer with 300 ms and begin countdown.

60—Issue front axle demand signal.

62—Is observed pressure at at least one front brake>2 bar?

64—Has timer expired?

66—Wait.

68—Issue rear axle demand signal.

FIG. 4 is a sequence flow diagram illustrating an embodiment corresponding to FIG. 2c where delivery rate of the fluid to the rear brakes is limited, at least initially, to a predetermined value that is relatively low with respect to that for the front brakes. FIG. 4 includes the following sequence steps:

70—Driver presses brake pedal.

72—Demand signal from external system.

74—Base-brake demand begins.

76—TC, ABS, VSC not active.

78—Issue front axle demand signal.

80—Set threshold pressure Pt=20 bar

Set rear-axle demand rate restriction to 67 bar/s.

82—Is rear axle demand pressure>Pt?

84—Wait.

86—Cancel rear-axle demand rate restriction.

1. A vehicle electro-hydraulic braking system of the type which can operate in a brake-by-wire mode in which hydraulic pressure is applied to brake actuators at the vehicle wheels in proportion to the driver's braking demand as sensed electronically at a brake pedal, wherein the pressure demand for the rear brake actuators is arranged to be delayed until at least one of two conditions has been fulfilled, namely (a) the pressure of at least one front brake actuator has reached a predetermined pressure, and/or (b) a delay threshold of a predetermined level has been exceeded and/or wherein delivery of fluid to the rear brakes is limited to a predetermined value that is relatively low with respect to that for the front brakes.

2. A braking system as claimed in claim 1, wherein said predetermined pressure is approximately 2bar.

3. A braking system as claimed in claim 1 or 2, wherein the delay threshold is between 100-300 ms.

4. A braking system as claimed in claim 1, 2 or 3 wherein said typical value is approximately 10% of the delivery of fluid to the front brakes.
